(19) United States
(12) Patent Application Publication
(10) Pub. No.: US 2015/0075480 A1
(43) Pub. Date: Mar. 19, 2015

(54) ENGINE

(71) Applicant: YAMAHA MOTOR POWER PRODUCTS KABUSHIKI KAISHA, Kakegawa-shi (JP)

(72) Inventor: Atsushi SUZUKI, Shizuoka (JP)

(21) Appl. No.: 14/484,481

(22) Filed: Sep. 12, 2014

(30) Foreign Application Priority Data
Sep. 13, 2013 (JP) 2013-191203

(51) Int. Cl. F01M 9/06; F02F 7/00; F02F 3/00

(52) U.S. Cl. CPC F01M 9/06; F02F 3/0069; F02F 3/0084; F02F 7/0004
USPC 123/193.6

(57) ABSTRACT

An engine includes a piston inside a cylinder, a crank shaft, a connecting rod, an oil dipper provided in a big end portion of the connecting rod, and a piston pin which connects pin boss regions of the piston to a small end portion of the connecting rod, and a crank case. The piston pin is rotatably movable with respect to the pin boss regions and the connecting rod. There are counter regions between the small end portion and the piston pin, a first counter region on a side closer to a tip portion of the connecting rod and a second counter region on a side closer to the big end portion of the connecting rod. The first counter region includes two ends located farther inward than two ends of the second counter region in an axial direction of the piston pin.

### BACKGROUND OF THE INVENTION

1. Field of the Invention

The present invention relates to engines, and more specifically to an Over Head Valve or OHV engine configured to use splash lubrication.

2. Description of the Related Art

An example of conventional techniques in this field is disclosed in JP-A 2004-218488.

JP-A 2004-218488 discloses an engine provided by an air-cooled, single-cylinder, four-cycle OHV engine, in which a big end portion of a connecting rod is formed with a splash section so as to splash oil stored inside a crank case bottom portion. The splashed oil, together with a mist of oil, finds ways into an oil supply path, to inlet/exhaust valves and a surrounding area inside a valve chamber. This arrangement makes it possible to lubricate the inlet/exhaust valves and a surrounding area without using an oil pump.

Such an engine as described above is capable of lubricating the inlet/exhaust valves and a surrounding area inside the valve chamber with oil, but is not capable of sufficiently lubricating a piston underside area including pin holes in pin boss regions, inner surfaces of a small end portion of the connecting rod, and outer circumferential surfaces of piston pin. This poses a risk that the connecting rod will not move smoothly with respect to the piston. The risk becomes especially high in cases where the connecting rod is designed not to have a conventional bearing metal commonly fitted into the small end portion.

### SUMMARY OF THE INVENTION

Therefore, preferred embodiments of the present invention provide an engine capable of keeping smooth movement of a connecting rod with respect to a piston.

According to an aspect of various preferred embodiments of the present invention, an engine includes a cylinder; a piston provided in the cylinder and including pin boss regions; a crank shaft configured to convert reciprocating movement of the piston into rotating movement; a connecting rod including a small end portion connected to the pin boss regions of the piston, and a big end portion connected to the crank shaft; an oil dipper provided in the big end portion of the connecting rod; a piston pin configured to connect the pin boss regions and the small end portion of the connecting rod; and a crank case provided at the cylinder and accommodating the crank shaft and the oil dipper. In this engine, the piston pin is rotatably movable with respect to the pin boss regions and the connecting rod. Further, counter regions between the small end portion and the piston pin include a first counter region which is closer to a tip portion of the connecting rod, and a second counter region which is closer to the big end portion of the connecting rod, and when the connecting rod is viewed from a direction which is perpendicular or substantially perpendicular to both an axial direction of the piston pin and an axial direction of the connecting rod, the first counter region has its two ends at positions located farther inward in the axial direction of the piston pin than two ends of the second counter region in the axial direction of the piston pin.

In a preferred embodiment of the present invention, the oil dipper, which is provided on the connecting rod, splashes oil which is stored inside the crank case, to supply the oil to an underside of the piston. In this process, the oil is supplied to an outer circumferential surface of the piston pin from between the pin boss regions and the small end portion of the connecting rod. In regard to the counter regions between the small end portion and the piston pin, the two ends of the first counter region are at positions located farther inward than the two ends of the second counter region in the axial direction of the piston pin. Therefore, oil which has arrived at the outer circumferential surface of the piston pin on the side closer to the first counter region is drawn as the piston pin rotates, and makes its way to a location between the piston pin and the small end portion of the connecting rod, and between the piston pin and the pin boss regions. Specifically, it is possible to sufficiently lubricate the underside area of the piston including pin holes in the pin boss regions, an inner surface of the small end portion of the connecting rod, and the outer circumferential surface of the piston pin. Therefore, the arrangement makes the movement of the connecting rod smooth with respect to the piston. The arrangement is particularly advantageous in configurations where the connecting rod is designed not to have a conventional bearing metal which is commonly fitted into the small end portion of the connecting rod.

Preferably, the small end portion of the connecting rod includes a first portion defining a portion closer to a tip portion of the connecting rod, and a second portion defining a portion closer to the big end portion of the connecting rod; and when the connecting rod is viewed from the direction which is perpendicular or substantially perpendicular to both the axial direction of the piston pin and the axial direction of the connecting rod, the first portion includes side surfaces at positions located farther inward than those of the second portion in the axial direction of the piston pin. The arrangement that the side surfaces of the first portion which is on the side closer to the tip portion of the small end portion of the connecting rod are at positions located farther inward than the side surfaces of the second portion which is on the side closer to the big end portion in the axial direction of the piston pin means that the portion closer to the tip portion is narrower than the portion closer to the big end portion, in the small end portion of the connecting rod. In this case, it becomes possible to shorten the length of the piston pin, and simultaneously to move the pin boss regions toward the center of the piston, in the piston underside region. This arrangement makes it possible to increase an oil contact area on the radially outer side than the pin boss regions, in the underside region of the piston, and therefore makes it possible to enhance cooling of the piston and to significantly reduce or prevent a temperature increase in the piston. Especially in cases where the connecting rod is designed not to have a conventional bearing metal which is commonly fitted into the small end portion of the connecting rod, the small end portion is often given an increased thickness. Even in such cases, various preferred embodiments of the present invention make it possible to have a sufficient amount of area for oil contact in the underside region of the piston, and to provide sufficient cooling to the piston.

Further preferably, the connecting rod is preferably made of an aluminum alloy, whereas the piston pin is preferably made of a ferrous alloy, for example. As described above, the connecting rod is preferably made of an aluminum alloy but the piston pin is preferably made of a ferrous alloy. By making the two members of materials that are mutually dissimilar from each other, good adhesion resistance is provided in the counter regions between the connecting rod and the piston pin. This eliminates the need for an expensive bearing metal, bushing or the like which must otherwise be fitted to the small end portion of the connecting rod and further, and the need for surface treatment to the small end portion of the connecting rod, thus making it possible to reduce cost of manufacture of the engine. Also, the pin boss regions which are closer to the center of the piston shortens a heat transfer path from a center region of the piston, via the pin boss regions and the piston pin, to the connecting rod. Further, by using an aluminum alloy, i.e., a material having a high thermal conductivity, for the connecting rod, the arrangement makes it possible to conductively remove heat from the center region of the piston and then effectively release it from the connecting rod, thus enhancing cooling of the piston.

Further, preferably, the pin boss regions overlap the big end portion side of the small end portion when viewed from a direction of a center axis of the cylinder. If the pin boss regions do not overlap the small end portion of the connecting rod when viewed from the direction of the center axis of the cylinder like in the conventional engines, the explosion in the engine exerts a bending load to the piston pin to act in a direction from the tip portion of the small end portion of the connecting rod to the big end portion. This can deform the piston pin, which in turn increases localized surface pressure from the piston pin to the pin boss regions and the connecting rod. However, if the pin boss regions overlap a portion of the small end portion which is closer to the big end portion when viewed from the direction of the center axis of the cylinder, the load exerted by the explosion in the engine to the piston pin in the direction from the tip portion of the small end portion of the connecting rod to the big end portion is received by the portion closer to the big end portion, of the small end portion of the connecting rod, and therefore the piston pin is less prone to deformation. Therefore, the arrangement improves durability of the piston, the piston pin and the connecting rod.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view from a front left view point, of an engine generator which includes an engine according to a preferred embodiment of the present invention.

FIG. 2 is a perspective view from a rear right view point, of the engine generator which includes the engine according to a preferred embodiment of the present invention.

FIG. 3 is an illustrative drawing, showing a longitudinal section of the engine.

FIG. 4A is a sectional view of a piston, whereas FIG. 4B is a bottom view thereof.

FIG. 5A is a side view of a connecting rod, whereas FIG. 5B is a partially unillustrated sectional view showing a small end portion of the connecting rod.

FIG. 6 is a side view, showing a state where the connecting rod is assembled to the piston.

FIG. 7 is a partially unillustrated sectional view of a region including the small end portion, showing the state where the connecting rod is assembled to the piston.

FIG. 8A is a sectional view of a conventional piston, whereas FIG. 8B is a bottom view thereof.

FIG. 9 is a partially unillustrated sectional view of a conventional example, showing a region including a small end portion where a connecting rod is assembled to the piston.

### DETAILED DESCRIPTION OF THE PREFERRED EMBODIMENTS

Hereinafter, preferred embodiments of the present invention will be described with reference to the drawings.

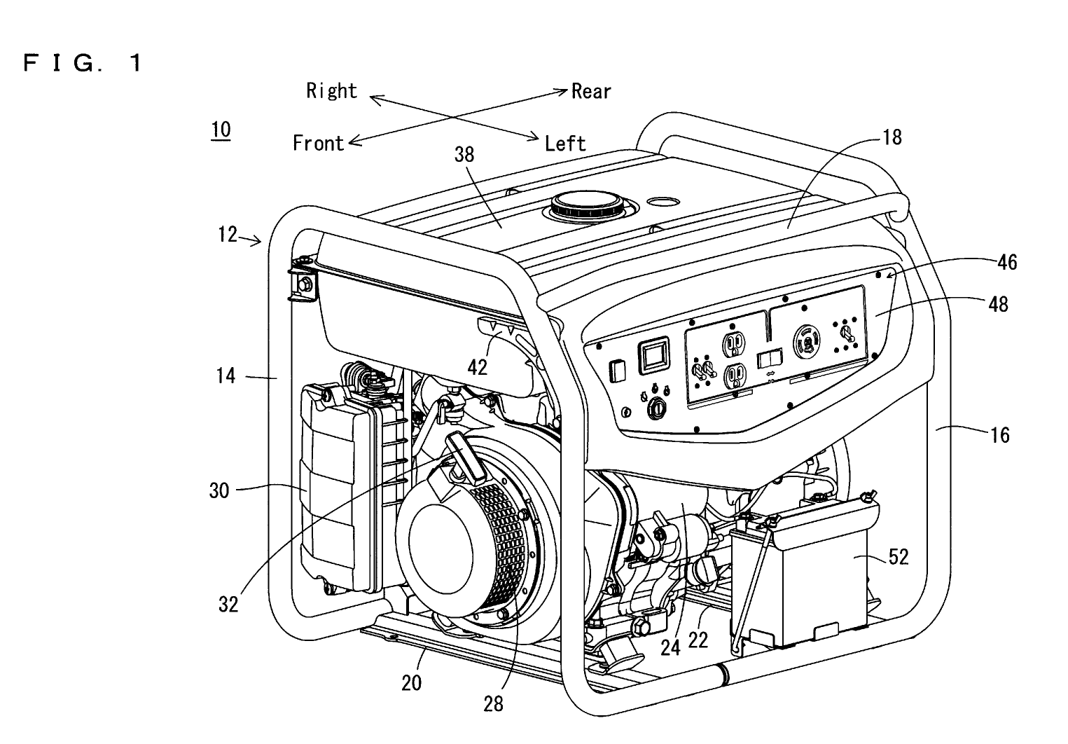

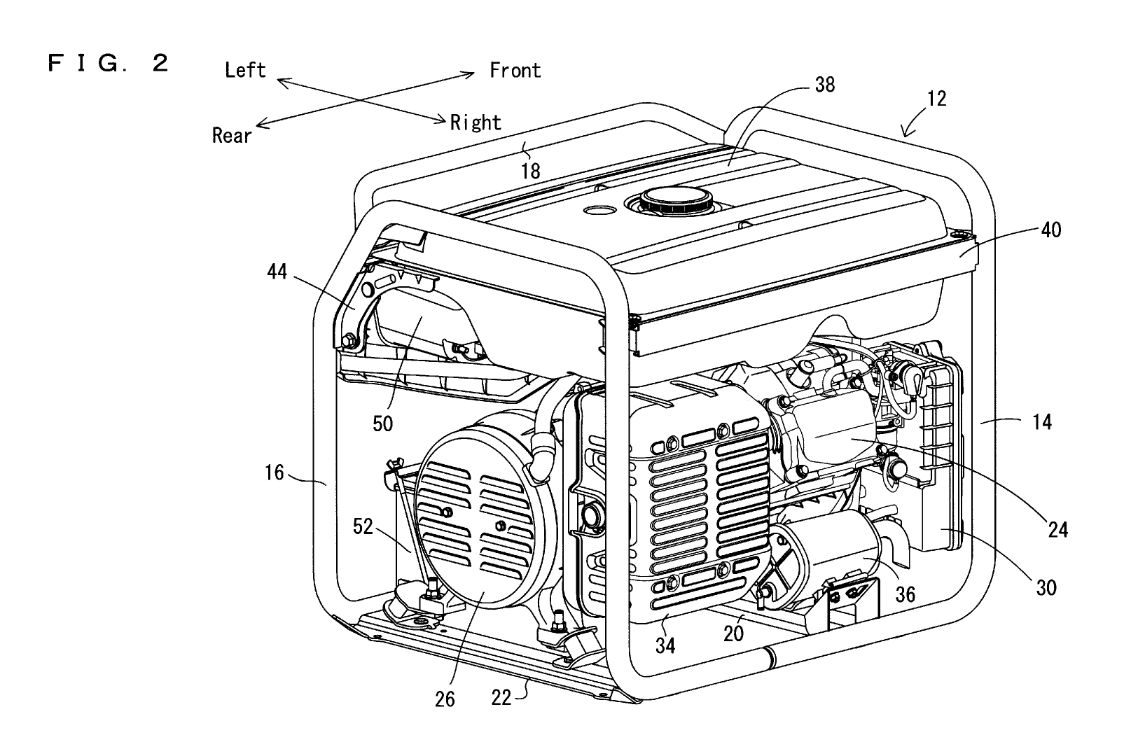

FIG. 1 and FIG. 2 show an engine generator 10 which includes an engine 24 (which will be described later) according to a preferred embodiment of the present invention. In the present specification, a “fore-aft direction” and a “left-right direction” in the engine generator 10 are defined as shown in FIG. 1 and FIG. 2 for the sake of descriptive convenience. Thus, a side on which the engine 24 is provided is a “front side”, a side on which a generator 26 (to be described later) is provided is a “rear side”, and a side on which an operation panel 48 (to be described later) is provided is a “left side”.

The engine generator 10 is a portable generator, including a generator frame 12. The generator frame 12 includes a front frame 14, a rear frame 16, an upper frame 18, and a pair of lower frames 20, 22. The front frame 14 is provided by a pipe-shaped member which is preferably formed into a general shape of inverted letter of U in a front view, whereas the rear frame 16 is provided by a pipe-shaped member which is preferably formed into a general shape of inverted letter of U in a rear view, for example. The front frame 14 and the rear frame 16 are connected with each other at both of their end portions. The upper frame 18 is provided by a pipe-shaped member and extends in the fore-aft direction, connecting upper left end portions of the front frame 14 and the rear frame 16, respectively. The upper frame 18 defines and serves as a grip. The lower frame 20 is a platy member extending in the left-right direction, connecting left and right lower portions of the front frame 14 with each other. The lower frame 22 is a platy member extending in the left-right direction, connecting left and right lower portions of the rear frame 16 with each other.

The engine 24 is installed on the lower frame 20, whereas the generator 26 is installed on the lower frame 22. The engine 24 and the generator 26 are arranged in the fore-aft direction, with the engine 24 being on the front side and the generator 26 being on the rear side. The engine 24 includes a crank shaft 66 (to be described later), which is connected with a rotating shaft (not illustrated) of the generator 26.

The engine 24 includes, on its front side, an air intake section 28 to introduce outside air. The air intake section 28 incorporates a cooling fan (not illustrated). An air cleaner 30 is provided on the right side of the air intake section 28. As the cooling fan is driven, outside air introduced from the air intake section 28 cools the engine 24. Near the air intake section 28, a recoil starter 32 is provided.

A muffler 34 is provided behind the engine 24, on the right side of the generator 26. Exhaust gas from the engine 24 is discharged to outside via the muffler 34. A canister 36 is provided below the engine 24. A fuel tank 38 is connected to the air cleaner 30 via the canister 36. Gasoline vapor from the fuel tank 38 is adsorbed in the canister 36.

The fuel tank 38 is provided to cover the engine 24 and the generator 26 from above. The fuel tank 38 stores fuel (for example, gasoline, in the present preferred embodiment) which is to be supplied to the engine 24. The fuel tank 38 has its right side portion attached to a support frame 40 which connects an upper right end portion of the front frame 14 and an upper right end portion of the rear frame 16 to each other. The fuel tank 38 has its left front portion and left rear portion connected to the front frame 14 and the rear frame 16 respectively via brackets 42 and 44.

An operation box 46 is provided on the left side of the fuel tank 38. The operation box 46 includes the operation panel 48, and a case 50 which is provided on the right side of the operation panel 48 and incorporates an operation section (not illustrated), etc. A battery 52 is provided below the case 50.

In the engine generator 10 described as above, the recoil starter 32 is pulled to rotate the crank shaft 66 and start the engine 24. As the engine 24 starts, the generator 26 starts its power generating operation. The electric power from the generator 26 can be taken out of the operation panel 48 or stored in the battery 52.

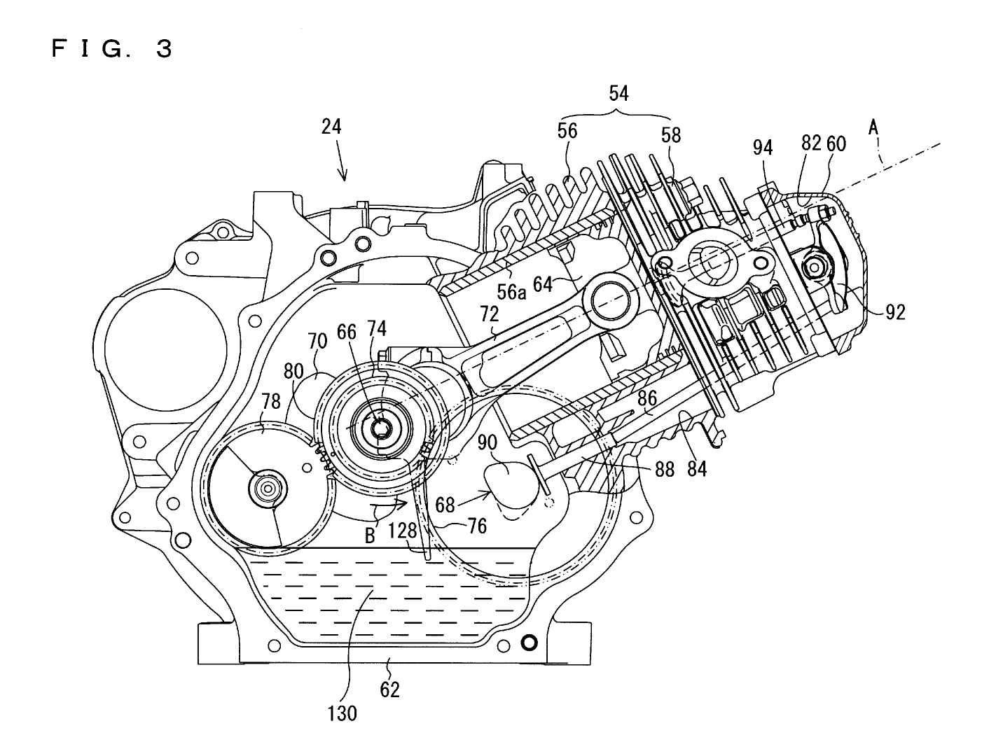

Reference will now be made to FIG. 3 to describe the engine 24.

The engine 24 preferably is an air-cooled, single-cylinder, four-cycle OHV engine (Over Head Valve Engine), for example, of a slanted type in which a cylinder center axis A is slanted obliquely. The engine 24 includes a cylinder 54. The cylinder 54 includes a cylinder body 56 and a cylinder head 58 which is attached to an upper end portion of the cylinder body 56. A cylinder head cover 60 is attached to an upper end portion of the cylinder head 58. A crank case 62 is provided in a lower portion of the cylinder body 56.

The cylinder body 56 includes an inner circumferential surface provided with a cylinder liner 56a. Inside the cylinder body 56, a piston 64 is provided slidably with respect to the cylinder liner 56a. The crank case 62 accommodates the crank shaft 66 and a cam shaft 68 which moves in association with the crank shaft 66. The crank shaft 66 is disposed horizontally. The crank shaft 66 and the cam shaft 68 are parallel or substantially parallel to each other. The cam shaft 68 is disposed not to interfere (contact) with crank webs 70 of the crank shaft 66. The piston 64 and the crank shaft 66 are connected to each other by a connecting rod 72, such that reciprocating movement of the piston 64 is converted into rotating movement by the crank shaft 66. The crank shaft 66 is provided with a drive gear 74, whereas the cam shaft 68 is provided with a driven gear 76 which rotates in association with rotation of the drive gear 74. The crank case 62 also accommodates a balancer 78. The balancer 78 is in engagement with a gear 80 provided in the crank shaft 66, to reduce vibration. As shown in FIG. 3, when the engine 24 is viewed from a position where the crank shaft 66 is located on the left side and the cam shaft 68 is located on the right side, rotation direction of the crank shaft 66 is counterclockwise as indicated by Arrow B.

From the cylinder body 56 to the cylinder head 58, there is provided a communication path 84 which provides communication between inside of the crank case 62 and inside of a rocker arm chamber 82 in the cylinder head cover 60. A pushrod 86, and a tappet 88 provided on an end portion of the pushrod 86 are inserted through the communication path 84. Inside the crank case 62, the tappet 88 has its tip portion contacted to a cam 90 of the cam shaft 68. The pushrod 86 includes another end portion contacted to a rocker arm 92 which is provided inside the rocker arm chamber 82. The rocker arm 92 drives an exhaust valve 94. Additionally, though not illustrated in FIG. 3, the engine 24 accommodates a pushrod, a tappet and a rocker arm to drive an inlet valve, in parallel or substantially in parallel to the pushrod 86, the tappet 88 and the rocker arm 92 to drive the exhaust valve 94.

Next, description will be made for an arrangement which includes the piston 64, the connecting rod 72 and their surroundings.

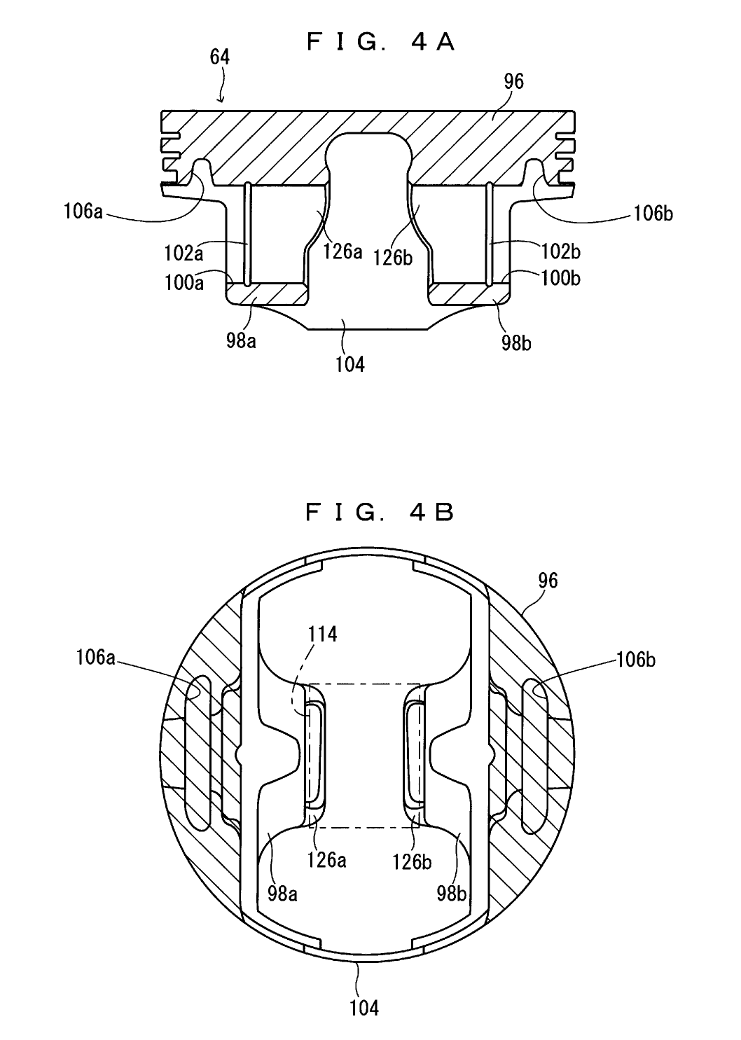

Referring to FIG. 4A and FIG. 4B, the piston 64 includes a piston head 96. The piston head 96 includes a lower surface including pin boss regions 98a, 98b to oppose to each other. The pin boss regions 98a, 98b include pin holes 100a, 100b respectively. The pin holes 100a, 100b are on a straight line so that a piston pin 118 (to be described later) can be inserted thereto. The pin holes 100a, 100b preferably include grooves 102, 102b respectively for circlips 120 (to be described later). The piston head 96 includes lower surface provided with a piston skirt 104. Further, the lower surface of the piston head 96 includes a plurality of recesses 106a, 106b. The recesses 106a, 106b preferably are I-shaped in a bottom view. The recesses 106a, 106b are on an outer side of the pin boss regions 98a, 98b, radially of the piston head 96, respectively. The recesses 106a, 106b increase a surface area of the piston 64, and help cooling of the piston 64.

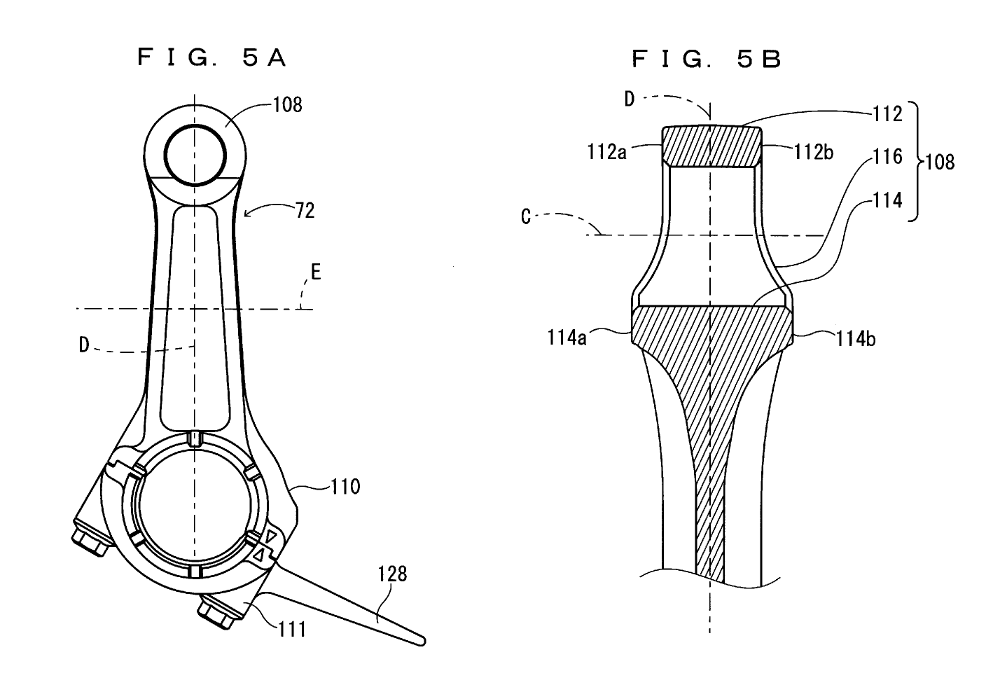

Referring to FIG. 5A and FIG. 5B, the connecting rod 72 is preferably made of an aluminum alloy, for example, and includes a small end portion 108 connected to the pin boss regions 98a, 98b of the piston 64, and a big end portion 110 connected to the crank shaft 66. The small end portion 108 of the connecting rod 72 includes a first portion 112 which is closer to a tip portion of the connecting rod 72; a second portion 114 which is closer to the big end portion 110 of the connecting rod 72; and a curved portion 116 which connects the first portion 112 and the second portion 114 with each other. As shown in FIG. 5B, the curved portion 116 includes a region of a smaller thickness extending from the second portion 114 toward the first portion 112, so that the first portion 112 has a smaller thickness than the second portion 114.

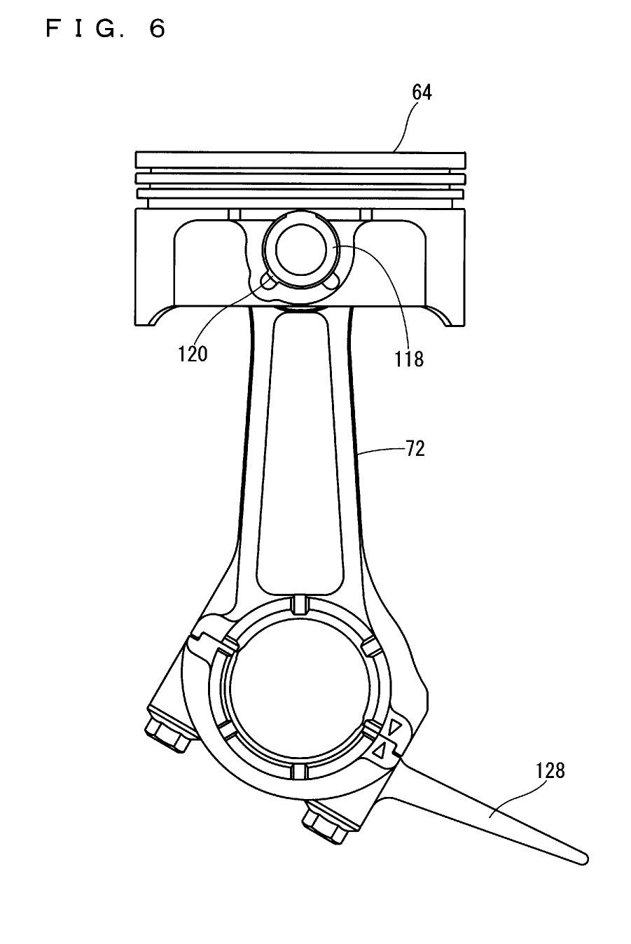

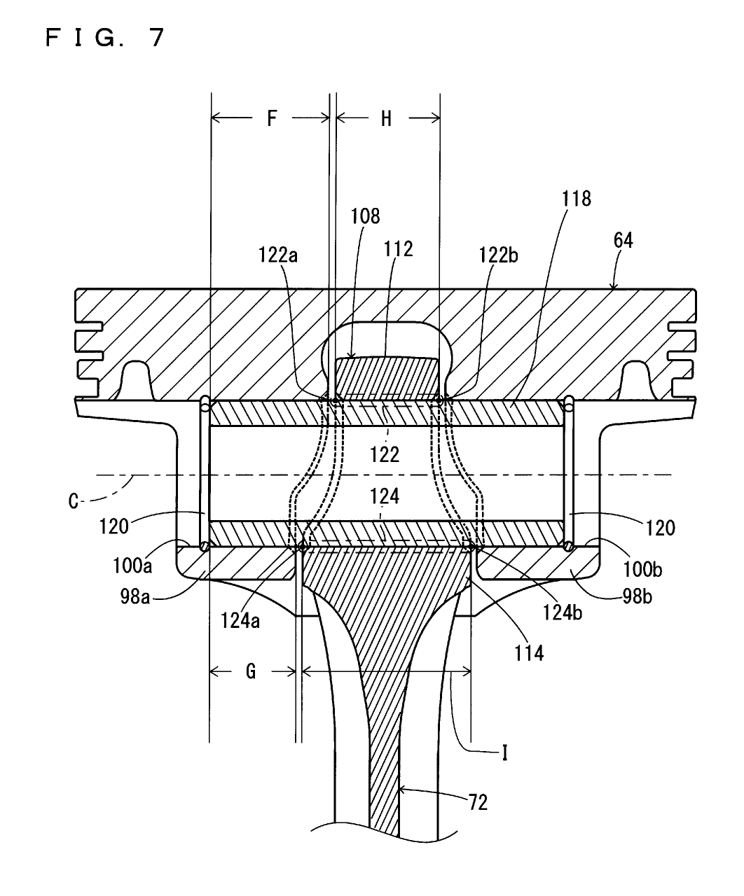

Referring to FIG. 6 and FIG. 7, the pin boss regions 98a, 98b and the small end portion 108 of the connecting rod 72 are connected by the piston pin 118. The piston pin 118 is inserted into the pin holes 100a, 100b of the pin boss regions 98a, 98b, and through the small end portion 108 of the connecting rod 72. The circlips 120 are fitted into the grooves 102a, 102b in the respective pin holes 100a, 100b. The circlips 120 support two ends of the piston pin 118, such that the piston pin 118 is fixed. The piston pin 118 is preferably made of a ferrous alloy, for example, and is rotatably movable with respect to the pin boss regions 98a, 98b and the connecting rod 72.

Referring to FIG. 5A, FIG. 5B and FIG. 7, when the connecting rod 72 is viewed from a direction E which is perpendicular to both of an axial direction C of the piston pin 118 and an axial direction D of the connecting rod 72, side surfaces 112a, 112b of the first portion 112 are located farther inward (closer to the axis of the connecting rod 72) than side surfaces 114a, 114b of the second portion 114, in the axial direction C of the piston pin 118. There are counter regions between the small end portion 108 and the piston pin 118; a first counter region 122 on a side closer to a tip portion of the connecting rod 72 and a second counter region 124 on a side closer to the big end portion 110 of the connecting rod 72. In the axial direction C of the piston pin 118, two ends 122a, 122b of the first counter region 122 are located farther inward (closer to the axis of the connecting rod 72) than two ends 124a, 124b of the second counter region 124 in the axial direction C of the piston pin 118.

Further, referring to FIG. 3, FIG. 4A and FIG. 4B, when viewed from a direction of the center axis A of the cylinder 54 (from a direction of sliding action of the piston 64), bulged portions 126a, 126b (upper portions of the pin boss regions 98a, 98b), i.e., portions of the pin boss regions 98a, 98b closer to the piston head 96 overlap a portion of the small end portion 108 (the second portion 114) which is a portion closer to the big end portion 110.

Referring to FIG. 5A and FIG. 6, the big end portion 110 of the connecting rod 72 is provided with an oil dipper 128. The oil dipper 128 is preferably made of an aluminum alloy for example. In the present preferred embodiment, the oil dipper 128 is preferably formed by die-casting integrally with a connecting rod cap 111 of the big end portion 110, for example. Referring to FIG. 3, the oil dipper 128 is in the crank case 62, and the crank case 62 stores oil 130 therein.

According to the engine 24 as described, the oil 130 is splashed by the oil dipper 128 provided on the connecting rod 72, to the cylinder body 56, the cylinder head 58, the cylinder head cover 60 and so on, directly or indirectly after spattering on the crank shaft 66, the cam shaft 68, etc., such that lubrication of the crank shaft 66, the cam shaft 68, the cylinder body 56, the rocker arm 92, etc. is achieved.

Also, the oil dipper 128 splashes the oil 130 stored inside the crank case 62 to underside surface of the piston 64. In this process, as will be clear from FIG. 7, the oil 130 passes through between the pin boss regions 98a, 98b and the small end portion 108 of the connecting rod 72, and reaches an outer circumferential surface of the piston pin 118. To elaborate on this arrangement about the counter regions regarding the small end portion 108 and the piston pin 118, the two ends 122a, 122b of the first counter region 122 are located farther inward than the two ends 124a, 124b of the second counter region 124 in the axial direction C of the piston pin 118. Therefore, oil 130 which has arrived at the outer circumferential surface of the piston pin 118 on the side closer to the first counter region 122 is drawn as the piston pin 118 rotates, and then finds its way to areas between the piston pin 118 and the small end portion 108 of the connecting rod 72, and between the piston pin 118 and the pin boss regions 98a, 98b. Specifically, it is possible with this arrangement to sufficiently lubricate and cool an underside region of the piston 64 such as the pin holes 100a, 100b of the pin boss regions 98a, 98b, an inner surface of the small end portion 108 of the connecting rod 72, the outer circumferential surface of the piston pin 118, etc. Therefore, the arrangement makes it possible to make smooth the movement of the connecting rod 72 with respect to the piston 64. The arrangement is particularly advantageous in configurations where the connecting rod is designed not to have a conventional bearing metal which is commonly fitted into the small end portion.

The arrangement that the side surfaces 112a, 112b of the first portion 112 which are provided on the side closer to the tip portion of the small end portion 108 of the connecting rod 72 are located farther inward than the side surfaces 114a, 114b of the second portion 114 which are provided on the side closer to the big end portion 110 in the axial direction C of the piston pin 118 means that the portion closer to the tip portion is narrower than the portion closer to the big end portion 110, in the small end portion 108 of the connecting rod 72. In this case, it becomes possible to shorten the length of the piston pin 118, and simultaneously to move the pin boss regions 98a, 98b toward the center of the piston 64, in the underside region of the piston 64.

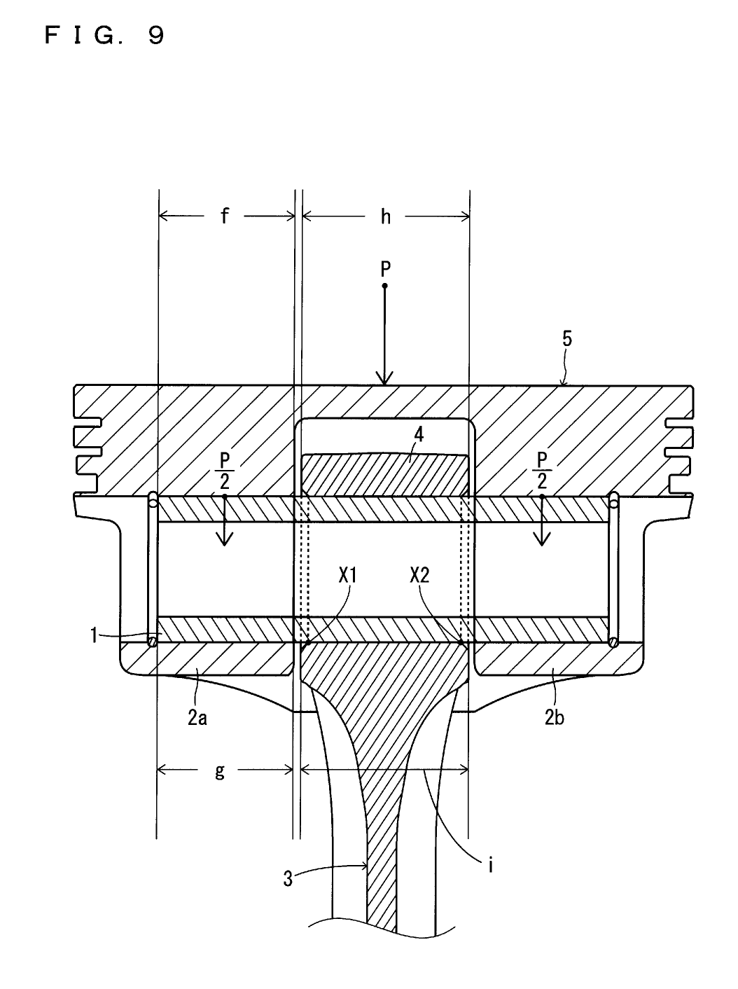

This will be elaborated hereinafter. In the preferred embodiment shown in FIG. 7, a distance from a tip of the piston pin 118 to a top portion of the pin boss region 98a(98b) in the axial direction C of the piston pin 118 will be called F; a distance from the tip of the piston pin 118 to a bottom portion of the pin boss region 98a(98b) in the axial direction C of the piston pin 118 will be called G; a thickness of a tip portion side (the first portion 112) of the small end portion 108 of the connecting rod 72 will be called H; and a thickness of the big end portion 110 side (the second portion 114) of the small end portion 108 of the connecting rod 72 will be called I. Likewise, in a conventional example shown in FIG. 9, a distance from a tip of a piston pin 1 to a top portion of a pin boss region 2a(2b) in an axial direction of the piston pin 1 will be called f; a distance from the tip of the piston pin 1 to a bottom portion of the pin boss region 2a(2b) in the axial direction of the piston pin 1 will be called g; a thickness of a tip portion side of a small end portion 4 of a connecting rod 3 will be called h; and a thickness of a big end portion side of the small end portion 4 of the connecting rod 3 will be called i. In this case, even if there is a relationship of F=f and I=i between the preferred embodiment shown in FIG. 7 and the conventional example shown in FIG. 9, there is still a relationship of G<g and H<h, so it is possible in the preferred embodiment in FIG. 7 to shorten the overall length of the piston pin to be less than that of the conventional example in FIG. 9, and therefore it is possible to move the pin boss regions closer to the center of the piston.

The arrangement makes it possible to increase an oil contact area (hatched regions in FIG. 4B) which is on the radially outer side than the pin boss regions 98a, 98b, of the piston 64, in the underside region of the piston 64, and therefore makes it possible to enhance cooling of the piston 64 and to reduce temperature increase in the piston 64. Especially in cases where the connecting rod is designed not to have a conventional bearing metal which is commonly fitted into the small end portion of the connecting rod, the small end portion is often given an increased thickness. Even in such cases, various preferred embodiments of the present invention make it possible to have a sufficient area for oil contact in the underside region of the piston, and to provide sufficient cooling to the piston.

Also, in the preferred embodiment in FIG. 7, the length of the pin boss region along the axial direction C can be shortened more than in the conventional example in FIG. 9, so as to decrease the weight of the pin boss region.

While the connecting rod 72 is preferably made of an aluminum alloy, the piston pin 118 is preferably made of a ferrous alloy, for example. By making the two members of materials that are mutually dissimilar from each other, good adhesion resistance is provided in the counter regions between the connecting rod 72 and the piston pin 118. This eliminates need for an expensive bearing metal, bushing or the like which must otherwise be fitted to the small end portion 108 of the connecting rod 72 and further, need for surface treatment to the small end portion 108 of the connecting rod 72, making it possible to reduce cost of manufacture of the engine 24. Also, the pin boss regions 98a, 98b which are closer to the center of the piston 64 shortens a heat transfer path from a center region of upper surface in the piston head 96, via the pin boss regions 98a, 98b and the piston pin 118, to the connecting rod 72. Further, by using an aluminum alloy, i.e., a material having a high thermal conductivity, for the connecting rod 72, the arrangement makes it possible to conductively remove heat from the center region of the upper surface in the piston head 96 and then effectively release it from the connecting rod 72, thus enhancing cooling of the piston 64.

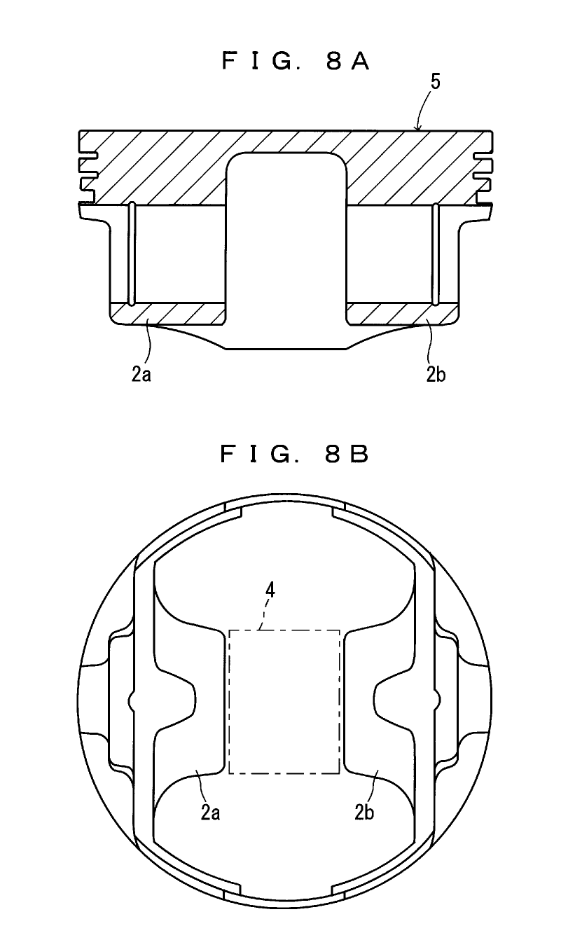

FIG. 8A, FIG. 8B and FIG. 9 shows a conventional example. As exemplified in these drawings, if the pin boss regions 2a, 2b do not overlap the small end portion 4 of the connecting rod 3 when viewed from the center axis of the cylinder (from the sliding direction of the piston 5), the explosion in the engine exerts a bending load to the piston pin 1 to act in a direction from the tip portion of the small end portion 4 to the big end portion of the connecting rod 3. Specifically, as shown in FIG. 9, as the piston 5 receives an explosion load P, two sides of the piston pin 1 come under a load of P/2, or in other words, load is concentrated onto specific regions in the piston pin 1 indicated as X1, X2. This can deform the piston pin 1, which in turn increases localized surface pressure from the piston pin 1 to the pin boss regions 2a, 2b and the connecting rod 3. However, referring now to FIG. 3, FIG. 4B and FIG. 7, in the engine 24 the upper portion (the bulged portions 126a, 126b) of the pin boss regions 98a, 98b overlap the portion closer to the big end portion 110 (the second portion 114), of the small end portion 108 of the connecting rod 72 when viewed from the center axial direction A of the cylinder 54 (the sliding direction of the piston 64). According to this arrangement, the load exerted by the explosion in the engine 24 to the piston pin 118 in the direction from the tip portion of the small end portion 108 of the connecting rod 72 to the big end portion 110 is received by the portion closer to the big end portion 110 (the second portion 114) of the small end portion 108 of the connecting rod 72, and therefore the piston pin 118 is less prone to deformation. Specifically, the bending load caused by the explosion in the engine 24 onto the piston pin 118 is reduced. Therefore, this arrangement improves durability of the piston 64, the piston pin 118 and the connecting rod 72.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. An engine comprising:
a cylinder;
a piston provided in the cylinder and including pin boss regions;
a crank shaft configured to convert reciprocating movement of the piston into rotating movement;
a connecting rod including a small end portion connected to the pin boss regions of the piston, and a big end portion connected to the crank shaft;
an oil dipper provided in the big end portion of the connecting rod;
a piston pin configured to connect the pin boss regions and the small end portion of the connecting rod; and
a crank case provided at the cylinder and accommodating the crank shaft and the oil dipper; wherein
the piston pin is rotatably movable with respect to the pin boss regions and the connecting rod; and
counter regions between the small end portion and the piston pin includes a first counter region which is closer to a tip portion of the connecting rod, and a second counter region which is closer to the big end portion of the connecting rod, and when the connecting rod is viewed from a direction which is perpendicular to both an axial direction of the piston pin and an axial direction of the connecting rod, the first counter region includes two ends located farther inward in the axial direction of the piston pin than two ends of the second counter region in the axial direction of the piston pin.

2. The engine according to claim 1, wherein the small end portion of the connecting rod includes a first portion defining a portion closer to a tip portion of the connecting rod, and a second portion defining a portion closer to the big end portion of the connecting rod; and
when the connecting rod is viewed from the direction which is perpendicular to both the axial direction of the piston pin and the axial direction of the connecting rod, the first portion includes side surfaces located farther inward than side surfaces of the second portion in the axial direction of the piston pin.

3. The engine according to claim 2, wherein the connecting rod is made of an aluminum alloy and the piston pin is made of a ferrous alloy.

4. The engine according to claim 2, wherein the pin boss regions overlap the big end portion side of the small end portion when viewed from a direction of a center axis of the cylinder.
